(19) United States
(12) Patent Application Publication
(10) Pub. No.: US 2026/0339579 A1
(43) Pub. Date: Oct. 29, 2026

(54) IMAGE FORMING APPARATUS AND CONTROL METHOD THEREFOR

(71) Applicant: SHARP KABUSHIKI KAISHA, Sakai City (JP)

(72) Inventor: Hiroyuki ISHIKURA, Sakai City (JP)

(21) Appl. No.: 19/640,575

(22) Filed: Apr. 7, 2026

(30) Foreign Application Priority Data
Apr. 11, 2025 (JP) 2025-065384

(51) Int. Cl. G06F 3/12

(52) U.S. Cl. CPC G06F 3/1236; G06F 3/121; G06F 3/1286

(57) ABSTRACT

An image forming apparatus includes: a first communicator that performs first communication using a first communication interface; a second communicator that performs second communication using a second communication interface that performs communication in accordance with the same wired communication method as the first communication interface; a storage that stores first connection information for the first communication and second connection information for the second communication; a display; and one or more controllers that acquire first update information that is new setting information for the first communication via the first communicator when a connection to the first communication interface has been detected, to compare the first update information with the second connection information, and to cause the display to display warning information for prompting check of at least one of wirings and network settings when it has been determined that the first update information matches the second connection information.

### CROSS-REFERENCE TO RELATED APPLICATION

The present application claims priority from Japanese Application JP2025-065384, the content of which is hereby incorporated by reference into this application.

### BACKGROUND OF THE INVENTION

### 1. Field of the Invention

The disclosure relates to an image forming apparatus, a control method therefor, and the like.

### 2. Description of the Related Art

In the related art, an image forming apparatus including a plurality of communication interfaces is known.

For example, in the related art, a multifunction peripheral that switches operations for each communication interface (connector) is disclosed. Specifically, the multifunction peripheral of the related art switches operation between a local area network (LAN) side connector and a wide area network (WAN) side connector.

### SUMMARY

In the related art, processing in a case in which cables connected to connectors are mistakenly interchanged is not disclosed.

According to some aspects of the present disclosure, when a plurality of communication interfaces are available, it is possible to provide, for example, an image forming apparatus that warns of an error relating to communication, and a control method therefor.

An aspect of the present disclosure relates to an image forming apparatus including: a first communicator that performs first communication using a first communication interface that performs communication in accordance with a given wired communication method; a second communicator that performs second communication using a second communication interface that performs communication in accordance with the same wired communication method as the first communication interface; a storage that stores first connection information that is setting information for the first communication and second connection information that is setting information for the second communication; a display; and one or more controllers that perform control to acquire first update information that is new setting information for the first communication via the first communicator when a connection to the first communication interface has been detected, to compare the first update information with the second connection information stored in the storage, and to cause the display to display warning information for prompting check of at least one of wirings and network settings when it has been determined that the first update information matches the second connection information.

Another aspect of the present disclosure relates to a control method for an image forming apparatus including a first communicator that performs first communication using a first communication interface that performs communication in accordance with a given wired communication method, a second communicator that performs second communication using a second communication interface that performs communication in accordance with the same wired communication method as the first communication interface, a storage, and a display. The control method includes: storing first connection information that is setting information for the first communication and second connection information that is setting information for the second communication in the storage; acquiring first update information that is new setting information for the first communication via the first communicator when a connection to the first communication interface has been detected; comparing the first update information with the second connection information stored in the storage; and causing the display to display warning information for prompting check of at least one of wirings and network settings when it has been determined that the first update information matches the second connection information.

### BRIEF DESCRIPTION OF THE DRAWINGS

FIG. 1 is a diagram illustrating an example of an external appearance of an image forming apparatus.

FIG. 2 is a diagram illustrating a configuration example of the image forming apparatus.

FIG. 3 is a diagram illustrating a network configuration example relating to the image forming apparatus.

FIG. 4 is a flowchart illustrating processing of the image forming apparatus.

FIG. 5 is a diagram illustrating an example of a screen for displaying warning information for prompting check of wiring.

FIG. 6 is a diagram illustrating an example of a screen for displaying warning information for prompting check of network settings.

FIG. 7 is a diagram illustrating another configuration example of the image forming apparatus.

### DETAILED DESCRIPTION OF THE INVENTION

Hereinafter, the present embodiment will be described with reference to the drawings. In the drawings, the same or equivalent elements are denoted by the same reference numerals, and duplicate description thereof will be omitted. The present embodiment to be described hereinafter does not unduly limit the content described in the claims. Further, not all configurations described in the present embodiment are necessarily essential configuration requirements of the present disclosure.

### 1. Example of System Configuration

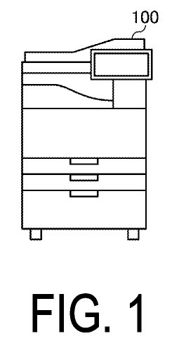

FIG. 1 is a diagram illustrating an example of an external appearance of an image forming apparatus 100. The image forming apparatus 100 may be a printer having a printing function, or may be a scanner having a scanning function. Further, the image forming apparatus 100 may be a multifunction peripheral (MFP) having various functions including a printing function and a scanning function. The image forming apparatus 100 may further have, for example, a copying function or a facsimile function.

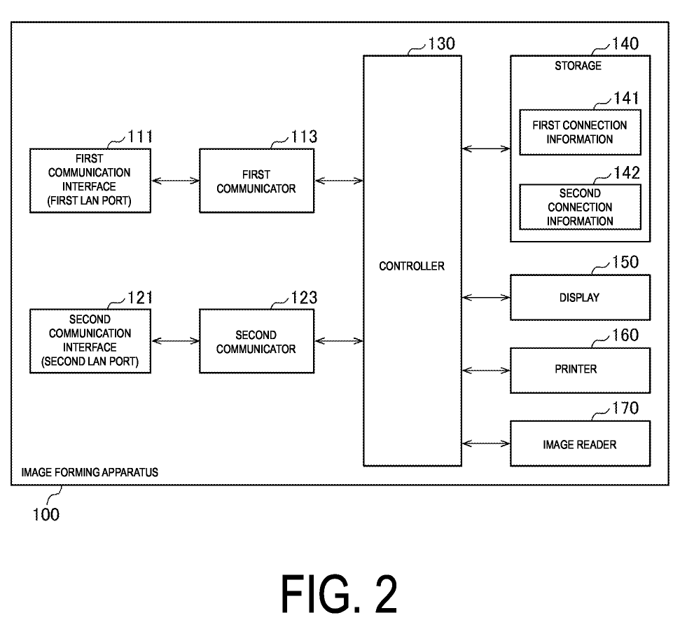

FIG. 2 is a block diagram illustrating a configuration example of the image forming apparatus 100. The image forming apparatus 100 includes a first communicator 113, a second communicator 123, one or more controllers 130, a storage 140, and a display 150. The image forming apparatus 100 may further include a first communication interface 111, a second communication interface 121, a printer 160, and an image reader 170. However, a configuration example of the image forming apparatus 100 is not limited to that illustrated in FIG. 2, and various modifications such as omitting some configurations or adding other configurations can be made.

The first communication interface 111 is a communication interface that performs communication in accordance with a given wired communication method. For example, the first communication interface 111 may be a communication port into which a terminal of a wired communication cable is inserted. More specifically, the first communication interface 111 may be a wired local area network (LAN) port. In other words, the first communication interface 111 is an interface that performs communication according to standards such as IEEE 802.3. However, the first communication interface 111 may be an interface corresponding to a communication method different from a wired LAN.

The second communication interface 121 is a communication interface that performs communication according to the same wired communication method as the first communication interface 111. For example, the second communication interface 121 may be a communication port into which a terminal of a wired communication cable is inserted and more specifically may be a wired LAN port. However, the second communication interface 121 may be an interface corresponding to a communication method different from the wired LAN.

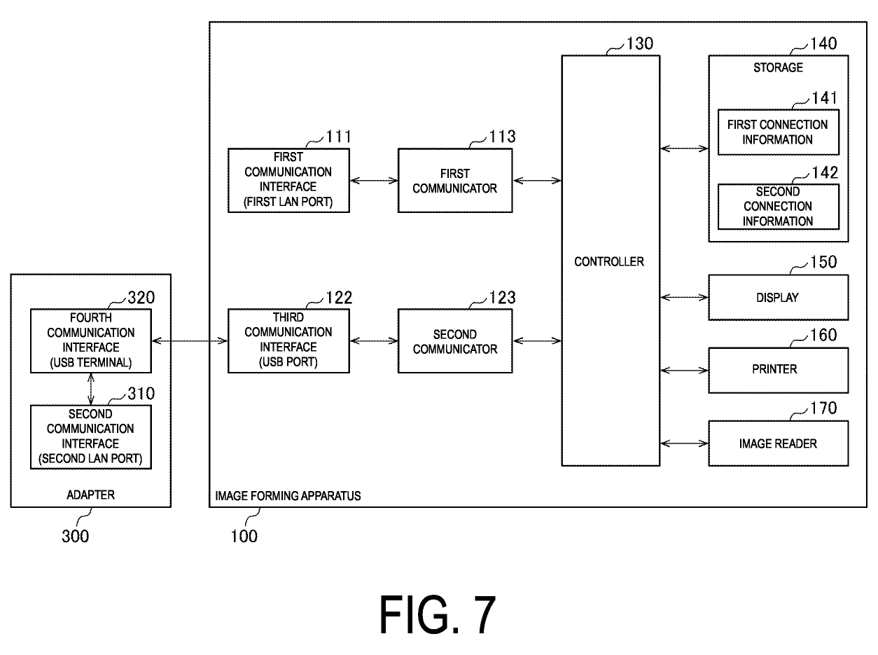

As illustrated in FIG. 2, the image forming apparatus 100 according to the present embodiment may include the first communication interface 111 and the second communication interface 121. In other words, the image forming apparatus 100 may be an MFP having two built-in LAN ports. However, the image forming apparatus 100 may include only one of the first communication interface 111 and the second communication interface 121, and the second communication interface (LAN port) may be provided outside the image forming apparatus 100 (for example, a second communication interface 310 to be described later with reference to FIG. 7). Further, both the first communication interface and the second communication interface are not precluded from being provided outside the image forming apparatus 100. Another configuration example of the image forming apparatus 100 will be described later with reference to FIG. 7.

The first communicator 113 performs communication using the first communication interface 111. Hereinafter, communication that the first communicator 113 executes using the first communication interface 111 is referred to as first communication. The first communicator 113 may be, for example, a communication control circuit (communication control chip) that operates the first communication interface 111. In the example of FIG. 2, the first communicator 113 is a control circuit that performs communication control corresponding to the wired LAN.

The second communicator 123 performs communication using the second communication interface 121. Hereinafter, communication that the second communicator 123 executes using the second communication interface 121 is referred to as second communication. The second communicator 123 may be, for example, a communication control circuit (communication control chip) that operates the second communication interface 121. In the example of FIG. 2, the second communicator 123 is a control circuit that performs communication control corresponding to the wired LAN.

The one or more controllers 130 control each unit included in the image forming apparatus 100. For example, the one or more controllers 130 are connected to the first communicator 113, the second communicator 123, the storage 140, the display 150, the printer 160, and the image reader 170 and control operations of these units.

The one or more controllers 130 are configured by the following hardware. The hardware may include at least one of a circuit that processes digital signals and a circuit that processes analog signals. For example, the hardware may be configured by one or more circuit apparatuses or one or more circuit elements mounted on a circuit board. The one or more circuit apparatuses are, for example, an integrated circuit (IC) and a field-programmable gate array (FPGA). The one or more circuit elements are, for example, a resistor and a capacitor.

Further, the one or more controllers 130 may be implemented by the following processor. The image forming apparatus 100 of the present embodiment includes a memory that stores information and a processor that operates based on the information stored in the memory. The information is, for example, programs and various types of data. The processor includes hardware. Various processors such as a central processing unit (CPU), a graphics processing unit (GPU), and a digital signal processor (DSP) may be used as the processor. The memory may be a semiconductor memory such as a static random access memory (SRAM) or a dynamic random access memory (DRAM), may be a register, may be a magnetic storage apparatus such as a hard disk drive (HDD), or may be an optical storage apparatus such as an optical disc apparatus. For example, the memory stores instructions that are readable by a computer, and functions of the one or more controllers 130 are implemented as processing by the processor executing the instructions. The instructions herein may be instructions in an instruction set constituting a program or may be instructions for instructing a hardware circuit of the processor to perform an operation.

The storage 140 is a work area of the one or more controllers 130 and stores various types of information. The storage 140 may be implemented by various memories, and the memory may be a semiconductor memory, may be a register, may be a magnetic storage apparatus, or may be an optical storage apparatus.

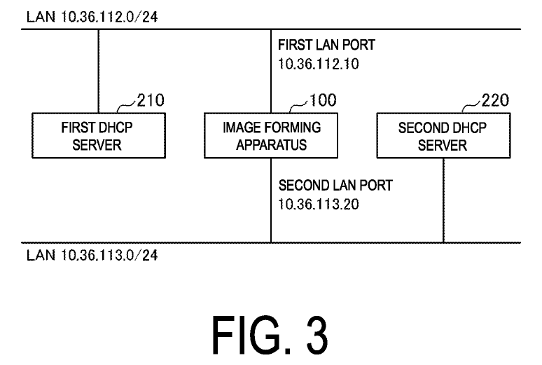

The storage 140 stores first connection information 141 that is setting information for the first communication and second connection information 142 that is setting information for the second communication. The setting information herein may include, for example, information transmitted from DHCP servers (a first DHCP server 210 and a second DHCP server 220 in FIG. 3) to be described later. Details of the setting information are omitted. Further, the storage 140 may store information not illustrated in FIG. 2, such as a user ID, password, and usage history (print history and scan history) of a user who uses the image forming apparatus 100.

The display 150 is a display that displays images. The display 150 may be implemented by, for example, a liquid crystal display or an organic EL display. The display 150 may be a user interface (UI) when a user uses functions of the image forming apparatus 100, such as a printing function and a scanning function. Further, the display 150 of the present embodiment may be implemented by a touch panel, and in this case, the display 150 and an operator not illustrated in FIG. 2 are integrally configured. Further, the operator may be provided separately from the display 150.

The printer 160 includes a printing mechanism that is a mechanical configuration for performing printing on a print medium. The printing function is implemented by the printer 160. For example, the printer 160 includes a conveyance roller that conveys a print medium in a conveyance direction and a conveyance motor that drives the conveyance roller. For example, when the image forming apparatus 100 is an electrophotographic image forming apparatus such as a laser printer, the printing mechanism includes a photosensitive drum, a charging roller, an exposure apparatus, a developing apparatus, a transfer roller, a fixing roller, and the like. Further, when the image forming apparatus 100 is an inkjet printer, the printing mechanism includes a carriage in which a print head is provided and a carriage motor that drives the carriage in a main scanning direction orthogonal to the conveyance direction. However, various schemes may be applied to the printer 160 of the present embodiment, and the printing mechanism is not limited thereto.

The image reader 170 includes a light emitter (not illustrated) that irradiates a document that is a reading target with light, and a light receiver (not illustrated) that receives reflected light or transmitted light of the light. The image reader 170 acquires image data that is a result of reading the document based on a light reception result of the light receiver. The scanning function is implemented by the image reader 170.

Further, the functions of the image forming apparatus 100 are not limited to the printing function and the scanning function. For example, the image forming apparatus 100 may transmit the image data of the document read by the image reader 170 to the outside (corresponding to a scanner function). Further, the image forming apparatus 100 may form, in color or monochrome, a read image of the document or an image received from outside on a sheet (corresponding to a copy function or a facsimile function). Further, the image forming apparatus 100 may have other functions such as a file server function.

FIG. 3 is a diagram illustrating a network configuration example relating to the image forming apparatus 100. As described above with reference to FIG. 2, the image forming apparatus 100 according to the present embodiment is capable of first communication using the first communication interface 111 and second communication using the second communication interface 121. In other words, the image forming apparatus 100 has a dual network configuration capable of being connected to two different networks.

As illustrated in FIG. 3, for example, the image forming apparatus 100 is connected to a first LAN via the first communication interface 111 (first LAN port) and is connected to a second LAN via the second communication interface 121 (second LAN port). For example, an Internet protocol (IP) address relating to the first communication interface 111 may be 10.36.112.10, and a network address corresponding to the first LAN may be 10.36.112.0/24. Further, an IP address relating to the second communication interface 121 may be 10.36.113.20, and a network address corresponding to the second LAN may be 10.36.113.0/24. Thus, the network address corresponding to the first LAN is different from the network address corresponding to the second LAN. Further, values of the IP addresses are merely examples, and specific values are not limited thereto. Further, in the example illustrated in FIG. 3, an example in which the IP address is an IPv4 address and a subnet mask is 255.255.255.0 is shown, but the subnet mask is not limited thereto. Further, the IP address may be an IPv6 address.

The IP address relating to the first LAN is provided by the first DHCP server 210. The IP address relating to the second LAN is provided by the second DHCP server 220.

One or both of the first LAN and the second LAN may be connected to a public communication network (for example, the Internet) via a layer 3 switch such as a router. In other words, even when the two communication interfaces of the image forming apparatus 100 are LANs, the image forming apparatus 100 is not precluded from being connected to a WAN via at least one of the LANs.

By adopting a dual network configuration, it is possible to separate functions to be provided to the respective LANs. For example, when the image forming apparatus 100 includes the printer 160 having the printing mechanism and the image reader 170 having a light emitter and a light receiver as described above, the one or more controllers 130 perform control relating to a plurality of functions including a printing function using the printer 160 and a scanning function using the image reader 170. The one or more controllers 130 perform control to execute a first function group among the plurality of functions via the first communication interface 111 and the first communicator 113 and perform control to execute a second function group among the plurality of functions via the second communication interface 121 and the second communicator 123. In this case, the first function group and the second function group may be different in the functions included therein.

For example, when the image forming apparatus 100 includes a printing function, a scan function, a copy function, a facsimile function, a file server function, and the like, the one or more controllers 130 perform control to provide all the functions in use via the first LAN and perform control to provide some (for example, only the printing function) of the functions in use via the second LAN. In this case, the second function group has a limited number of functions included therein as compared with the first function group.

Such function control is suitable, for example, in a case in which the image forming apparatus 100 is an MFP placed in an office, which is a case in which the first LAN is a standard network for employees, and the second LAN is a limited network for guests. This makes it possible to provide, for each network, appropriate functions in accordance with attributes of a user who uses a network.

Alternatively, the one or more controllers 130 may provide a printing function, a scan function, a copy function, and a facsimile function in the use via the first LAN, and may provide a file server function in the use via the second LAN.

Such function control is suitable, for example, in a case in which the image forming apparatus 100 is a multifunction terminal installed in a commercial facility (for example, a convenience store), the first LAN is a network for general users (customers), and the second LAN is a network for management users. For example, the general user uses the image forming apparatus 100 via the Internet and the first LAN by using the user’s portable terminal apparatus or the like. Further, the management user uses the image forming apparatus 100 via the second LAN that is, for example, an internal network of the commercial facility. Thus, it becomes possible to allow only limited management users to view information that should be highly confidential, such as sales aggregation data. The one or more controllers 130 may provide other functions such as a printing function, a scan function, a copy function, and a facsimile function in the second LAN.

Alternatively, a degree of port opening corresponding to one of the first communication interface 111 and the second communication interface 121 may be lower than a degree of port opening corresponding to the other. The port opening herein includes control to permit communication using a given port number. The port number is a sub-address associated with the IP address, and is information for specifying a program (protocol) that is a target to which a packet is transmitted. For example, in the case in which the first LAN is a standard network for employees and the second LAN is a limited network for guests as described above, the one or more controllers 130 make a degree of port opening of the first LAN higher than a degree of port opening of the second LAN. The high degree of port opening indicates that the number of ports to be opened is large in a narrow sense, but is not limited thereto. For example, the degree of port opening may be determined by comparing use frequencies (communication amounts) of the respective ports and increasing a weight of the port having a high use frequency. Thus, it becomes possible to vary, depending on the network, the extent to which connections from external apparatuses are permitted.

The first communication (communication using the first LAN) and the second communication (communication using the second LAN) according to the present embodiment are not limited to those in which both the functions and the degrees of port opening are different, and either one thereof may be common. Further, contrary to the above-described example, various modifications can be made as to how each network is used, such as setting the first LAN to the network for guests and setting the second LAN to the network for employees.

As described above, the image forming apparatus 100 according to the present embodiment includes the first communicator 113, the second communicator 123, the one or more controllers 130, the storage 140, and the display 150. When a connection (cable connection) to the first communication interface 111 has been detected, the one or more controllers 130 acquire first update information that is new setting information for the first communication via the first communicator 113. The one or more controllers 130 compares the first update information with the second connection information 142 stored in the storage 140. When the one or more controllers 130 have determined that the first update information matches the second connection information 142, the one or more controllers 130 perform control to cause the display 150 to display the warning information for prompting check of at least one of wirings and network settings.

The image forming apparatus 100 of the present embodiment performs communication using two wired communication interfaces. For example, the image forming apparatus 100 can be connected to two different LANs as described above. By making the functions provided to the respective LANs and the degrees of port opening different, it becomes possible to allow the image forming apparatus 100 to be flexibly used without redundantly providing hardware resources such as a storage for each application. In this case, it is not necessary to use different communication interfaces (the LAN and the WAN) as in the related art.

Further, in the present embodiment, when the first update information that is new setting information for the first communication is acquired through a connection to the first communication interface 111, the one or more controllers 130 perform a process of comparing the first update information with the stored second connection information 142. Thus, it is possible to determine whether information allocated to the second communication interface 121 at a past connection is allocated to the first communication interface 111 in a new connection. That is, the one or more controllers 130 can determine whether a cable that should be connected to the second communication interface 121 is mistakenly connected to the first communication interface 111. A case in which the one or more controllers 130 have determined that the first update information matches the second connection information 142 is a case in which there is a high possibility of a cable connection error. The warning information is displayed at this time, making it possible to suppress use of the image forming apparatus 100 in a state in which the wirings are erroneous.

For example, when the image forming apparatus 100 is moved, cables connected to the first communication interface 111 and the second communication interface 121 are once removed, and then the cable connection is newly performed at a movement destination. In this case, connections to the two communication interfaces are mistakenly interchanged, there is a possibility that functions or the degrees of port opening corresponding to the respective LANs differ from those assumed. In a case in which the first LAN described above is a standard network for employees and the second LAN is a limited network for guests, when cables are mistakenly interchanged (swapped), it is conceivable that the functions of the image forming apparatus 100 are not sufficiently provided to the employees, and that all the functions of the image forming apparatus 100 are mistakenly provided to guests. The same applies to port opening, and there may be a possibility that connections that should be permitted are prohibited and connections that should be prohibited are permitted. In this respect, in the present embodiment, since it is possible to determine a wiring error and prompt check when an error is suspected, it is possible to suppress execution of communication in an erroneous wiring state. Further, as will be described later, the one or more controllers 130 may perform control to prohibit communication by setting the first communication interface 111 to be inactive, in addition to displaying the warning information.

The first update information may match the second connection information 142 due to network settings in the image forming apparatus 100. Therefore, the warning information for the present embodiment may include information for prompting check of the network settings. Here, the network setting may include information that is set in the image forming apparatus 100 (static information to be set by a user), which is, for example, information for specifying enabling/disabling of the DHCP, a static IP address and subnet, a domain name system (DNS) server, a security authentication method, and the like. On the other hand, the setting information for the first communication and the second communication may be dynamic information acquired from a DHCP server.

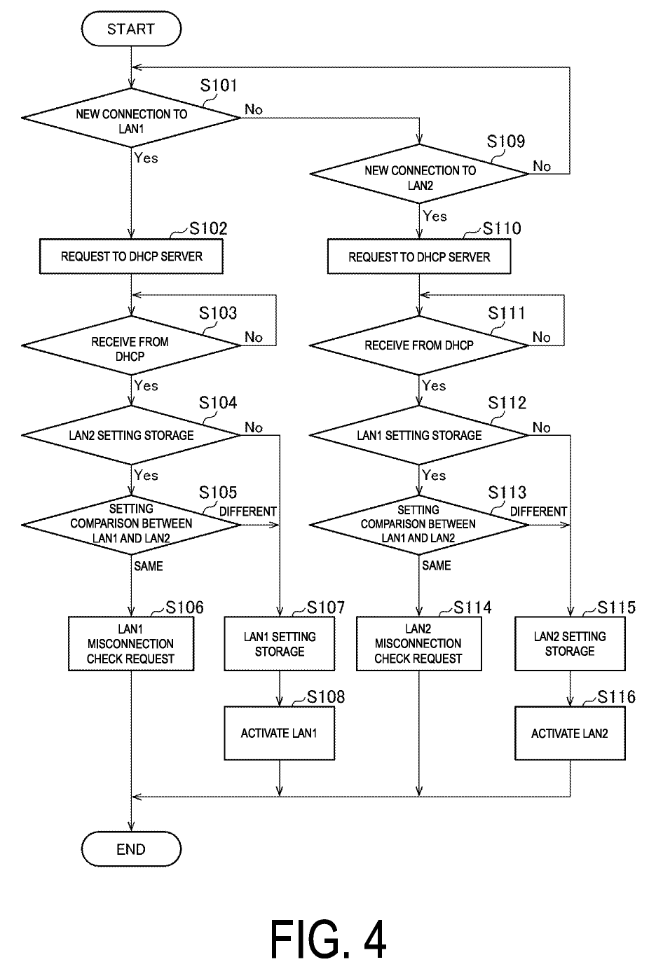

Further, when a connection to the second communication interface 121 has been detected, the one or more controllers 130 may acquire second update information that is new setting information for the second communication via the second communicator 123, compares the second update information with the first connection information 141 stored in the storage 140, and perform control to cause the display 150 to display the warning information when determining that the second update information matches the first connection information 141. Thus, when there is a possibility that a cable that should be connected to the first communication interface 111 is mistakenly connected to the second communication interface 121, it becomes possible to warn the user. Details of the processing will be described later with reference to FIGS. 4-6. Hereinafter, an example in which determination processing regarding an erroneous connection is executed in both of a case in which the connection to the first communication interface 111 has been detected and a case in which the connection to the second communication interface 121 has been detected will be described, but determination processing regarding the second communication interface 121 may be omitted.

Further, some or all of the processing performed by the image forming apparatus 100 of the present embodiment may be implemented by a program. For example, the program may be a program implementing processing to be executed by the one or more controllers 130 of the image forming apparatus 100. The processing to be executed by the one or more controllers 130 will be described later with reference to FIG. 4.

The program according to the present embodiment can be stored in, for example, a non-transitory information storage medium (information storage apparatus) that is a computer-readable medium. The information storage medium can be implemented by, for example, an optical disc, a memory card, an HDD, or a semiconductor memory. The semiconductor memory is, for example, a ROM. The one or more controllers 130 perform various types of processing of the present embodiment based on the program stored in the information storage medium. That is, the information storage medium stores a program for causing a computer to function as the one or more controllers 130. The computer is an apparatus including an input apparatus, a processor, a storage, and an output unit. Specifically, the program according to the present embodiment is a program for causing the computer to execute each step that will be described later with reference to FIG. 4.

Further, the scheme of the present embodiment is applicable to a control method for the image forming apparatus 100. As described above, the image forming apparatus includes the first communicator that performs the first communication using the first communication interface that performs communication in accordance with the given wired communication scheme, the second communicator that performs the second communication using the second communication interface that performs communication according to the same wired communication scheme as the first communication interface, the storage, and the display. The control method includes: causing the storage to store the first connection information that is the setting information for the first communication and the second connection information that is the setting information for the second communication; acquiring the first update information that is the new setting information for the first communication via the first communicator when the connection to the first communication interface has been detected; comparing the first update information with the second connection information stored in the storage; and causing the display to display the warning information for prompting check of at least one of the wiring and the network settings when determining that the first update information matches the second connection information.

### 2. Flow of Process

FIG. 4 is a flowchart illustrating processing of the image forming apparatus 100. In step S101, the one or more controllers 130 determine whether there has been a new connection to the first communication interface 111 via the first communicator 113. For example, the one or more controllers 130 determine whether a cable has been newly connected to the first LAN port.

When there has been the new connection to the first communication interface 111 (step S101: Yes), the one or more controllers 130 request a DHCP server connected to the first communication interface 111 to transmit information via the first communicator 113 in step S102. In step S103, the one or more controllers 130 determine whether a response of the DHCP server corresponding to the request has been received via the first communicator 113. The response herein is information received from the DHCP server and corresponds to the setting information.

The setting information according to the present embodiment may include at least one of an IP address, a netmask, a gateway IP address, and DNS server information, each acquired from the DHCP server. Thus, it becomes possible to execute each process such as a determination as to the wiring error based on information from the DHCP server. The IP address and the subnet included in the setting information relating to the first communication are an IP address allocated to the first communication interface 111 and information for specifying a network address in the IP address. Similarly, the IP address and the subnet included in the setting information relating to the second communication are an IP address allocated to the second communication interface 121 and information for specifying a network address in the IP address. The gateway IP address is an IP address of a node that connects an internal network to an external network, and is, for example, an IP address of a router. The DNS server information is information for specifying a server that executes name resolution processing of a domain name system (DNS).

When the response of the DHCP server has not been received (step S103: No), the one or more controllers 130 repeatedly execute the process of step S103. In other words, in step S103, the one or more controllers 130 wait until the response from the DHCP server is received.

When the one or more controllers 130 receive the first update information that is new setting information relating to the first communication from the DHCP server (step S103: Yes), the one or more controllers 130 determine whether the second connection information 142 that is the setting information relating to the second communication is stored in the storage 140 in step S104. For example, when there is a history in which a process of step S115 to be described later has been executed in the past, the second connection information 142 is stored in the storage 140.

When the second connection information 142 is stored (step S104: Yes), the one or more controllers 130 perform a comparison process between the first update information and the second connection information 142 in step S105.

For example, the setting information may include the IP address and the netmask, each acquired from the dynamic host configuration protocol (DHCP) server. The one or more controllers 130 may compare information designated by the netmask in the IP address included in the first update information with information designated by a netmask in the IP address included in the second connection information 142 to determine whether the first update information matches the second connection information 142. The subnet herein is information for specifying bits corresponding to the network address in the IP address, and may be a subnet mask in IPv4 or may be a prefix length in IPv6. In other words, the one or more controllers 130 may compare a network address newly acquired for the first communication with a network address already stored for the second communication. When the two network addresses match, the one or more controllers 130 determine that the first update information matches the second connection information 142.

However, the comparison process in step S105 is not limited to a process of comparing network addresses. For example, the one or more controllers 130 may determine whether a gateway IP address included in the first update information matches a gateway IP address included in the second connection information. Alternatively, the one or more controllers 130 may determine whether a DNS server specified by the DNS server information included in the first update information matches a DNS server specified by DNS server information included in the second connection information. Further, the one or more controllers 130 may combine two or more of a process of comparing network addresses, a process of comparing gateway IP addresses, and a comparison process of the DNS server. For example, when it has been determined that there is a match in a predetermined number or more of the two or more comparison processes, the one or more controllers 130 determine that the first update information matches the second connection information 142. The predetermined number here may be one, may be a number corresponding to all of the two or more comparison process, or may be a number therebetween.

When it has been determined that the first update information matches the second connection information 142 (step S105: same), the one or more controllers 130 perform control to display the warning information in step S106. The warning information here may be information for prompting check of wirings, or may be information for prompting the check of the network settings.

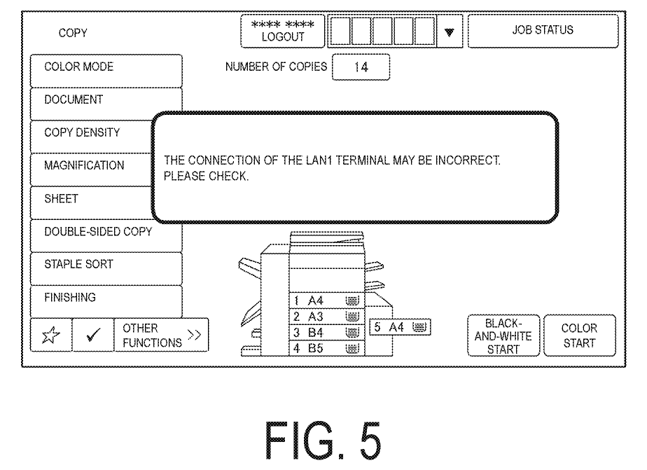

FIG. 5 is an example of a screen for displaying the warning information for prompting the check of the wirings. The screen illustrated in FIG. 5 is displayed, for example, on the display 150. For example, the warning information may be text information for prompting check of terminal connection, such as “The connection of the LAN1 terminal may be incorrect. Please check.” The “connection of the LAN1 terminal” here represents a connection corresponding to the first communication interface 111, but a specific expression is not limited thereto. Further, the warning information is not limited to the text information, and may be an image, an icon, or the like. Further, in the example of FIG. 5, an example in which the warning information is displayed in a pop-up manner on a copy screen for presenting information relating to copying is shown. The copy screen includes, for example, a display object relating to various settings relating to copying (color mode, document, copy density, magnification, paper, double-sided copying, staple sort, finishing), a display object for selecting the number of copies, and a display object for instructing execution of copying. However, the warning information may be displayed in a pop-up manner on another screen, or may be displayed in a manner different from a pop-up.

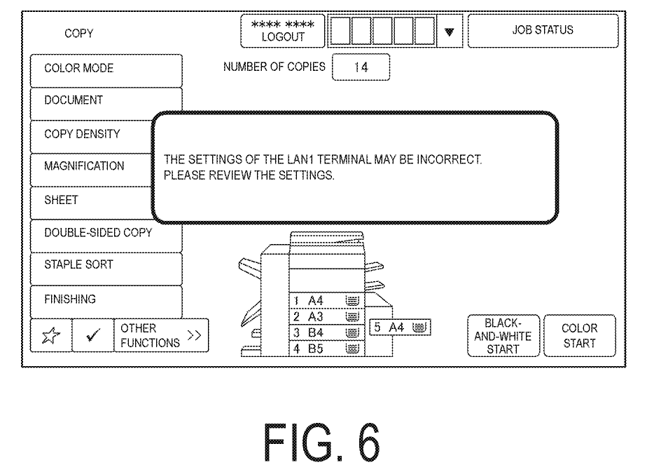

FIG. 6 is an example of a screen for displaying the warning information for prompting the check of the network settings. The screen illustrated in FIG. 6 is displayed, for example, on the display 150. For example, the warning information may be text information for prompting check of network settings, such as “The settings of the LAN1 terminal may be incorrect. Please review the settings.” A display mode of the warning information in FIG. 6 is the same as that in FIG. 5, for example, the warning information is displayed in a pop-up manner over the copy screen. However, various modifications are possible in the display mode, as in the case of the warning information for prompting the check of the wirings.

Further, the warning information is not limited to information for prompting check of either the wirings or the network settings, and may be information for prompting check of both the wirings and the network settings.

Although not illustrated in FIG. 4, when it has been determined that the first update information matches the second connection information 142 (step S105: same), the one or more controllers 130 may perform control to set the first communication using the first communication interface 111 to inactive. Thus, it becomes possible to suppress communication execution in a state in which wiring or the like may be incorrect. This control may be control to change the first communication set to active in step S101, to inactive. Alternatively, the first communication may be set to inactive except for communication with the DHCP server and the control to set the first communication to inactive here may be control to maintain the inactive state.

When the second connection information 142 is not stored in the storage 140 (step S104: No), there is no comparison target for the first update information, and therefore, this is not determined to be the wiring error. Accordingly, in step S107, the one or more controllers 130 perform control to store the first update information in the storage 140 as new first connection information 141. The process in step S107 may be a process of overwriting existing first connection information 141 with the first update information, or may be a process of adding the first update information to the first connection information 141 while maintaining past first connection information 141.

In step S108, the one or more controllers 130 perform control to set the first communication using the first communication interface 111 to active. This control may be control to change the first communication set to inactive except for communication with the DHCP server, to an active state. Alternatively, this control may be control to maintain a state of the first communication set to active in step S101.

Further, when it has been determined that the first update information does not match the second connection information 142 (step S105: different), the one or more controllers 130 perform control to cause the storage 140 to store the first update information as the new first connection information 141 in step S107 and to set the first communication to active in step S108. A case in which the first update information does not match the second connection information 142 corresponds to a case in which wirings are not mistakenly interchanged and there is a high likelihood that no problem will occur even when communication is permitted as is. Accordingly, the one or more controllers 130 perform the control to set the first communication using the first communication interface 111 to active, thereby causing appropriate communication to be executed.

As illustrated in FIG. 4, in the present embodiment, the first update information relating to the first communication interface 111 is compared with the second connection information 142 relating to the second communication interface 121. In other words, in the scheme of the present embodiment, in branching as to whether to display the warning information (step S106) or to set the first communication to active (step S108), it is not necessary to consider a relationship between the first update information, which is the new setting information relating to the first communication interface 111, and the first connection information 141, which is the existing setting information relating to the first communication interface 111. This is because, even if the setting information relating to the first communication changes, it is conceivable that the likelihood of wiring being mistakenly interchanged is low when the setting information relating to the first communication does not match the setting information for the second communication.

Accordingly, when it has been determined that the first update information does not match the second connection information 142 (step S105: different), the one or more controllers 130 may perform the control to set the first communication using the first communication interface 111 to active even when the first update information does not match the first connection information 141 stored in the storage 140. Thus, since a display of an excessive warning is suppressed, improvement in user convenience becomes possible.

The one or more controllers 130 may execute a determination process (not illustrated in FIG. 4) as to whether the first update information matches the first connection information 141 stored in the storage 140. For example, when the first update information matches the first connection information 141 stored in the storage 140, updating of the first connection information 141 is unnecessary, and therefore, the one or more controllers 130 may omit the storage control shown in step S107 and perform control to set the first communication shown in step S108 to active. On the other hand, when the first update information does not match the first connection information 141 stored in the storage 140, the one or more controllers 130 perform the storage control shown in step S107 to perform a process of updating the first connection information 141 to the latest information, and also perform control to set the first communication shown in step S108 to active. Thus, it is possible to appropriately switch whether to execute the storage control in step S107 based on whether the first connection information 141 is updated.

However, a process of determining whether the first update information matches the first connection information 141 stored in the storage 140 is not essential. For example, when it has been determined that the first update information does not match the second connection information 142 (step S105: different), the one or more controllers 130 may always execute both the storage control shown in step S107 and the active control shown in step S108 regardless of whether the first update information matches the first connection information 141 stored in the storage 140.

The above is a flow of a process when a new connection relating to the first communication interface 111 has been performed (step S101: Yes). The one or more controllers 130 may perform a similar process for a new connection relating to the second communication interface 121.

For example, when the new connection relating to the first communication interface 111 is not detected (step S101: No), the one or more controllers 130 determine whether there has been a new connection to the second communication interface 121 via the second communicator 123 in step S109. For example, the one or more controllers 130 determine whether a cable has been newly connected to the second LAN port. When it has been determined that there has been no new connection to the second communication interface 121 (step S109: No), the one or more controllers 130 return to step S101 and continue the process.

When it has been determined that there has been the new connection to the second communication interface 121 (step S109: Yes), the one or more controllers 130 request a DHCP server connected to the second communication interface 121 to transmit information via the second communicator 123 in step S110. In step S111, the one or more controllers 130 determine whether a response from the DHCP server corresponding to the request has been received via the second communicator 123. The response here corresponds to the setting information received from the DHCP server.

When the response from the DHCP server has not been received (step S111: No), the one or more controllers 130 repeatedly execute the process of step S111, thereby waiting until the response from the DHCP server is received.

When second update information that is new setting information relating to the second communication has received from the DHCP server (step S111: Yes), the one or more controllers 130 determine whether first connection information 141, which is the setting information relating to the first communication, is stored in the storage 140 in step S112.

When the first connection information 141 is stored (step S112: Yes), the one or more controllers 130 perform the comparison process between the second update information and the first connection information 141 in step S113. The specific processing is the same as the comparison process between the first update information and the second connection information 142. For example, the one or more controllers 130 perform the a process of comparing network addresses specified by the IP address and the netmask.

When it has been determined that the second update information matches the first connection information 141 (step S113: same), the one or more controllers 130 perform control to display the warning information in step S114. The warning information is the same as in the example described above with reference to FIGS. 5 and 6, except that the content is changed to a warning relating to the second communication interface 121.

When it has been determined that the second update information matches the first connection information 141 (step S113: same), the one or more controllers 130 may perform control to set the second communication using the second communication interface 121 to inactive.

When the first connection information 141 is not stored in the storage 140 (step S112: No), there is no comparison target for the second update information, and therefore, this is not determined to be the wiring error. Accordingly, in step S115, the one or more controllers 130 perform control to store the second update information in the storage 140 as new second connection information 142. In step S116, the one or more controllers 130 perform control to set the second communication using the second communication interface 121 to active.

When it has been determined that the second update information does not match the first connection information 141 (step S113: different), the one or more controllers 130 perform control to cause the storage 140 to store the second update information as the new second connection information 142 in step S115, and setting the second communication to active in step S116.

As in the processing relating to the first communication interface 111 described above, in the scheme of the present embodiment, in branching as to whether to display the warning information (step S114) or to set the second communication to active (step S116), it is not necessary to consider a relationship between the second update information and the existing second connection information 142. Accordingly, when it has been determined that the second update information does not match the first connection information 141 (step S113: different), the one or more controllers 130 may perform the control to set the second communication using the second communication interface 121 to active even if the second update information does not match the second connection information 142 stored in the storage 140. In this case, the one or more controllers 130 may determine whether the second update information matches the second connection information 142 stored in the storage 140, or may not determine whether the second update information matches the second connection information 142.

An example in which, when the new connection to the first communication interface 111 has been detected (step S101: Yes) and when the new connection to the second communication interface 121 has been detected (step S109: Yes), a process of determining whether to display the warning information (steps S102 to S108 and S110 to S116) is performed has been shown above. However, a trigger for starting the process of determining whether to display the warning information is not limited thereto. For example, the process of determining whether to display the warning information may be executed with activation of the image forming apparatus 100 as a trigger. Alternatively, the process of determining whether to display the warning information may be executed with elapse of a predetermined time as a trigger. Alternatively, two or more of these triggers may be used in combination.

### 3. Modification Examples

FIG. 7 is a block diagram illustrating another configuration example of the image forming apparatus 100. As illustrated in FIG. 7, the second communication interface according to the present embodiment may be a communication interface provided outside the image forming apparatus 100. For example, the image forming apparatus 100 may include the second communicator 123 and a third communication interface 122 connected to the second communicator 123. The third communication interface 122 is an interface in accordance with a communication method different from that of the first communication interface 111, and may be, for example, a universal serial bus (USB) port.

The second communication interface may be included in an adapter 300 connected to the third communication interface 122. For example, the adapter 300 may include the second communication interface 310 and a fourth communication interface 320. The second communication interface 310 is an interface using the same communication method as the first communication interface 111, and is a LAN port in a narrow sense. The fourth communication interface 320 is an interface for connection to the third communication interface 122 of the image forming apparatus 100, and is a USB terminal in a narrow sense. In this example, the adapter 300 is a USB-connected LAN adapter. The third communication interface 122 and the fourth communication interface 320 may correspond to type A of the USB, may correspond to type C, or may correspond to micro USB. Further, the third communication interface 122 and the fourth communication interface 320 may be interfaces in accordance with a communication method other than the USB.

In this case, the second communicator 123 performs second communication using the second communication interface 310 via other communication interfaces (the third communication interface 122 and the fourth communication interface 320). Even in this case, since there remains a possibility of the wiring error using two LAN terminals, it is possible to apply the scheme of the present embodiment described above.

Further, FIG. 7 shows an example in which the second communication interface 310 is provided outside the image forming apparatus 100, but the second communication interface 121 may be built into the image forming apparatus 100 and the first communication interface may be provided outside the image forming apparatus 100. Further, both the first communication interface and the second communication interface are not precluded from being provided outside the image forming apparatus 100.

Although the present embodiment has been described in detail as above, those skilled in the art will readily understand that many modifications are possible without substantially departing from the novel matters and effects of the present embodiment. Accordingly, all of such modifications are included in the scope of the present disclosure. For example, in the specification or the drawings, a term described at least once together with a broader or synonymous different term can be replaced with the different term at any place in the specification or the drawings. Further, all combinations of the present embodiment and the modification examples are also included in the scope of the present disclosure. Further, the configuration, operation, and the like of the image forming apparatus and the like are not limited to those described in the present embodiment, and various modifications can be made.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An image forming apparatus, comprising:
a first communicator that performs first communication using a first communication interface that performs communication in accordance with a given wired communication method;
a second communicator that performs second communication using a second communication interface that performs communication in accordance with the same wired communication method as the first communication interface;
a storage that stores first connection information that is setting information for the first communication and second connection information that is setting information for the second communication;
a display; and
one or more controllers that perform control to acquire first update information that is new setting information for the first communication via the first communicator when a connection to the first communication interface has been detected, to compare the first update information with the second connection information stored in the storage, and to cause the display to display warning information for prompting check of at least one of wirings and network settings when it has been determined that the first update information matches the second connection information.

2. The image forming apparatus according to claim 1, wherein the one or more controllers perform control to set the first communication using the first communication interface to active when it has been determined that the first update information does not match the second connection information.

3. The image forming apparatus according to claim 2, wherein the one or more controllers perform control to cause the storage to store the first update information as new first connection information when it has been determined that the first update information does not match the second connection information and when the first update information does not match the first connection information stored in the storage.

4. The image forming apparatus according to claim 1, wherein the one or more controllers perform control to acquire second update information that is new setting information for the second communication via the second communicator when a connection to the second communication interface has been detected, to compare the second update information with the first connection information stored in the storage, and to cause the display to display the warning information when it has been determined that the second update information matches the first connection information.

5. The image forming apparatus according to claim 1, wherein the one or more controllers perform control to set the first communication using the first communication interface to inactive when it has been determined that the first update information matches the second connection information.

6. The image forming apparatus according to claim 1, wherein the setting information includes at least one of an Internet protocol (IP) address, a netmask, a gateway IP address, and domain name system (DNS) server information, each acquired from a dynamic host configuration protocol (DHCP) server.

7. The image forming apparatus according to claim 1, wherein
the setting information includes an Internet protocol (IP) address and a netmask, each acquired from a dynamic host configuration protocol (DHCP) server, and
the one or more controllers compare information designated by the netmask in the IP address included in the first update information with information designated by the netmask in the IP address included in the second connection information, thereby determining whether the first update information matches the second connection information.

8. The image forming apparatus according to claim 1, further comprising:
a printer having a printing mechanism; andan image reader including a light emitter and a light receiver,wherein the one or more controllersperform control relating to a plurality of functions including a printing function using the printer and a scanning function using the image reader,perform control to execute a first function group among the plurality of functions via the first communication interface and the first communicator, andperform control to execute a second function group among the plurality of functions via the second communication interface and the second communicator, andthe first function group and the second function group differ in included functions.

9. The image forming apparatus according to claim 1, wherein a degree of port opening corresponding to one of the first communication interface and the second communication interface is lower than a degree of port opening corresponding to the other.

10. A control method for an image forming apparatus including a first communicator that performs first communication using a first communication interface that performs communication in accordance with a given wired communication method, a second communicator that performs second communication using a second communication interface that performs communication in accordance with the same wired communication method as the first communication interface, a storage, and a display, the control method comprising:
storing first connection information that is setting information for the first communication and second connection information that is setting information for the second communication in the storage;acquiring first update information that is new setting information for the first communication via the first communicator when a connection to the first communication interface has been
detected;comparing the first update information with the second connection information stored in the storage; andcausing the display to display warning information for prompting check of at least one of wirings and network settings when it has been determined that the first update information matches the second connection information.
